(19) United States
(12) Patent Application Publication
(10) Pub. No.: US 2018/0250666 A1
(43) Pub. Date: Sep. 6, 2018

(54) Improvements in and Relating to Biomanufacturing Apparatus

(71) Applicant: General Electric Company, Schenectady, NY (US)

(72) Inventors: Praveen Paul, Bangalore (IN); Manoj Ramakrishna, Bangalore (IN); Anoop Bhargav, Bangalore (IN); Haresh Digambar Patil, Bangalore (IN); Sebastian John, Bangalore (IN); Manish Uddhaorao Choudhary, Bangalore (IN); Pradeep Kumar, Bangalore (IN); Nivedita Phadke, Bangalore (IN)

(73) Assignee: General Electric Company, Schenectady, NY (US)

(21) Appl. No.: 15/755,088

(22) PCT Filed: Aug. 25, 2016
(86) PCT No.: PCT/EP2016/070116

§ 371 Date: Feb. 25, 2018

(30) Foreign Application Priority Data
Aug. 25, 2015 (IN) 2632/DEL/2015
Oct. 19, 2015 (GB) 1518426.0
Aug. 15, 2016 (IN) 201611027846

(51) Int. Cl. B01L 1/02; B01L 7/02; B01L 7/04

(52) U.S. Cl. CPC B01L 1/025; B01L 7/02; B01L 7/04; B01L 2300/043; B01L 2300/18; B01L 2300/0809; B01L 2300/123; B01L 2300/047; B01L 2300/048

(57) ABSTRACT

Disclosed is biomanufacturing apparatus (1) comprising a housing (20), a substantially enclosed bioreactor chamber (30) inside the housing and a further substantially enclosed region (36) inside the housing containing electrical parts and/or electronic control components, the chamber (30) including: a tray (40) for supporting a bioreactor, a tray support (45) including a mechanism (44,47) for rocking the tray in use the tray (40) including a heater (42) for contacting a bioreactor and heating the same, and the apparatus further comprising secondary heating (53) for heating air surrounding the tray.

### FIELD OF THE INVENTION

The present invention relates to biomanufacturing apparatus, for example for cell culturing. In particular, the invention relates to bioreactor apparatus in the form of single instruments, and plural instruments arranged into a biomanufacturing system for optimising the usage of laboratory and cell culturing space for biomanufacturing.

### BACKGROUND OF THE INVENTION

Cell culture, for example the culture of mammalian, bacterial or fungal cells, may be carried out to harvest the living cells for therapeutic purposes and/or to harvest biomolecules, such as proteins or chemicals (e.g. pharmaceuticals) produced by the cells. As used herein, the term “biomolecule” can mean any molecule, such as a protein, peptide, nucleic acid, metabolite, antigen, chemical or biopharmaceutical that is produced by a cell or a virus. Herein, the term biomanufacturing is intended to encompass the culturing or multiplication of cells, and the production of biomolecules. The term bioreactor is intended to encompass a generally enclosed volume capable of being used for biomanufacturing.

The cells are generally grown in large scale (10,000 to 25,000 litre capacity) bioreactors which are sterilisable vessels designed to provide the necessary nutrients and environmental conditions required for cell growth and expansion. Conventional bioreactors have glass or metal growth chambers which can be sterilized and then inoculated with selected cells for subsequent culture and expansion. Media within the growth chambers are often agitated or stirred by the use of mechanical or magnetic impellers to improve aeration, nutrient dispersal and waste removal.

In recent years, there has been a move towards ‘single use’ bioreactors which offer smaller batch sizes, greater production flexibility, ease of use, reduced capital cost investment and reduced risk of cross-contamination. These systems can also improve the efficiency of aeration, feeding and waste removal to increase cell densities and product yields. Examples include WAVE™ bags (GE Healthcare) mounted on rocking platforms for mixing, to the introduction of stirred-tank single-use vessels such as those available from Xcellerex Inc (GE Healthcare). With the advent of ‘personalised medicine’, autologous cell therapies requiring many small batches of cells to treat patients with unique cell therapies has become important.

Manufacturing facilities, such as tissue culture laboratories, for the production of cells and biomolecules, have traditionally been custom designed and carried out in clean environments to reduce the risk of contamination. Such facilities are costly to run and maintain and also to modify if priorities or work demands change. Work stations for maintaining or harvesting the cells within the bioreactors require a specific ‘footprint’ which occupies a significant floor space in the culture laboratory. As the workstations spend much of their time unattended, while the cells are growing in the bioreactors, the laboratory space is not efficiently or effectively used.

An improvement is proposed in WO 2014122307, wherein the laboratory space required for cell culture is reduced by the provision of customised workstations and storage bays for bioreactors, on which, conventional WAVE type bioreactors and ancillary equipment can be supported. Large supporting frameworks are required for that equipment.

U.S. Pat. No. 6,475,776 is an example of an incubator for cell culture dishes, which has a single incubator housing and multiple shelves, however this type of equipment is not suitable for housing bioreactors.

What is needed is the ability to stack multiple bioreactors one on top of another, closely spaced side by side, in a system that is simple to load, operate and maintain. Ideally such bioreactors should be capable of tradition fed batch manufacturing where cells are cultured typically over 7 to 21 days, as well as perfusion type manufacturing where cells can be cultured for longer periods, but waste products are continually or regularly removed, and biomolecules may be harvested.

In addition, accurate and reliable control of the cell culture environment is vital for successful cell culturing. Where multiple bioreactors are in close proximity, this control is more important because potential heating sources are closely spaced. Many of the available bioreactors use the WAVE rocking technology for obtaining high cell densities. The cells are grown in a single use cell bag bioreactor. This single use cell bag bioreactor is placed on a rocking platform of the bioreactor. There are many parameters which are vital in creating an optimum environment for production of high quality and high density cells e.g. rocking speed, dissolved oxygen, pH, perfusion rate, and temperature of the cell culture. For an optimum cell growth, the cell culture needs to be heated and maintained at a particular temperature which depends on the type of cell. For example, all mammalian cells need to be maintained at 37° C. for the optimum growth rate. This is usually done by placing the cell bag on a platform which has a heater pad or a heater plate. The heater pad or the heater plate heats and maintains the cell bag contents at the required set point. To ensure that the cells do not get overheated during the cell expansion process, it is very important that the cells are not heated beyond the set point at any point of time. The inventors have found that this temperature regime can be difficult to achieve when the same heating platform is used to heat cell culture volumes as low as 50 ml and as high as 2000 ml.

Another problem that is common in the bioreactors is the loss in cells due to condensation. The cells inside the cell bag are maintained at the set point, of 37° C., while the ambient temperature can be around 24° C. As a result, condensation is inevitable and occurs within 30 minutes of the cell bag contents reaching 37° C. There is an unacceptable loss of water from the cell culture which results from that condensation. As starting volumes of cells for the cell expansion process are reduced, this effect becomes more pronounced. About a ⅓ water volume loss after 24 hours has been reported that when the starting cell volume was 50 ml. Condensation is more noticeable as the ambient temperature gets lower. Condensation loss leads to increase in osmolality which in turn causes a change in the pH. pH is one of the important parameters to be maintained constant for cell culture. Different cell lines grow well in specific pH—for example most mammalian cell lines grow best at pH 7.4

The inventors have recognised that a heating system is required which can efficiently heat low volume cell cultures without overheating cell, as well as efficiently manage heating of higher volume of cell culture for example when those cells are expanded.

### SUMMARY OF THE INVENTION

The invention provides an arrangement according to claim 1 having preferred features defined by claims dependent on claim 1.

The invention extends to any combination of features disclosed herein, whether or not such a combination is mentioned explicitly herein. Further, where two or more features are mentioned in combination, it is intended that such features may be claimed separately without extending the scope of the invention.

### BRIEF DESCRIPTION OF THE DRAWINGS

The invention can be put into effect in numerous ways, illustrative embodiments of which are described below with reference to the drawings, wherein:

FIG. 1a shows a pictorial view of an embodiment of biomanufacturing apparatus;

FIG. 1b shows the apparatus of FIG. 1a stacked to form a biomanufacturing system 2;

FIG. 2 shows a different pictorial view of the apparatus shown in FIG. 1;

FIG. 3 shows another pictorial view of the apparatus shown in FIG. 1, including a bioreactor loaded inside the apparatus;

FIGS. 4 and 5 show two pictorial views of a further embodiment of biomanufacturing apparatus, in different configurations;

FIGS. 6a, 6b, 6c and 6d show a partial sectional view of the apparatus shown in FIGS. 1 and 2;

FIG. 7 shows an enlarged partial view of the apparatus shown in FIGS. 1 and 2;

FIG. 8 shows a sectional plan view of the apparatus shown in FIGS. 1 and 2;

FIG. 8a shows a flow diagram for a method of heating a bioreactor; and

FIG. 9 shows a schematic representation of the functioning of the apparatus shown in FIGS. 1 and 2.

The invention, together with its objects and the advantages thereof, may be understood better by reference to the following description taken in conjunction with the accompanying drawings, in which like reference numerals identify like elements in the Figures.

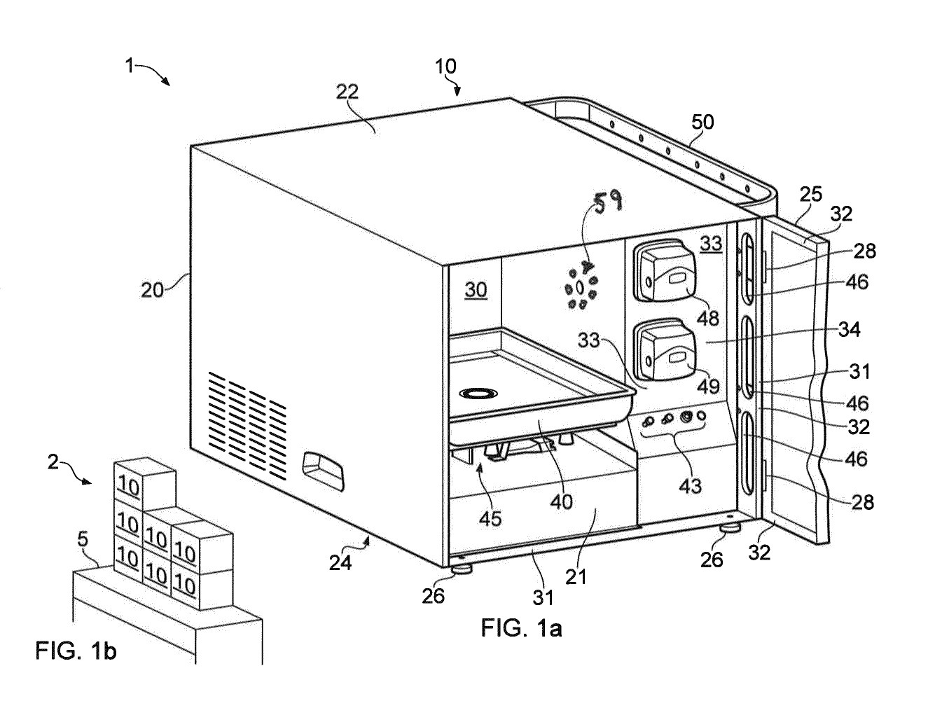

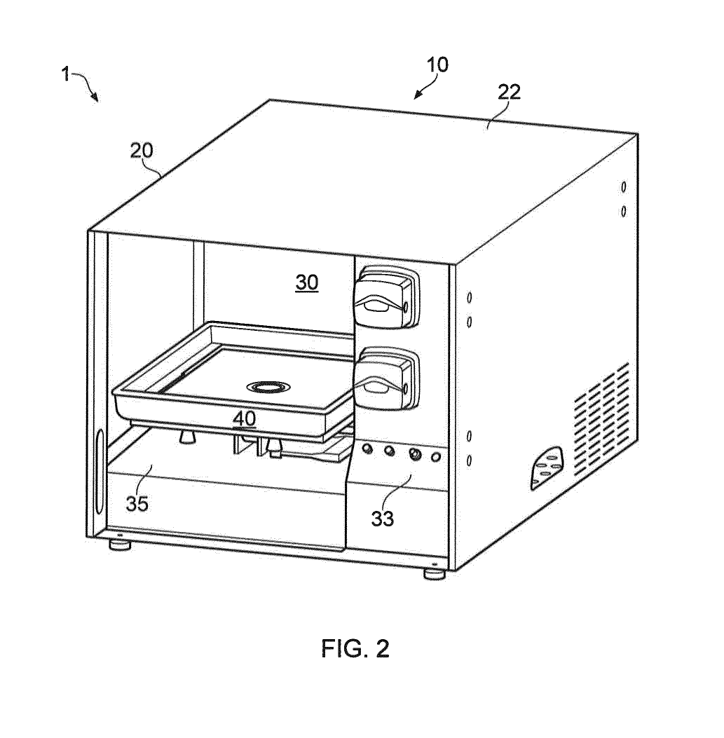

Referring to FIG. 1a there is shown biomanufacturing apparatus 1 including a generally self-contained instrument 10 which includes a generally cuboid or box-shaped housing 20 having generally flat upper and bottom sides 22 and 24. The bottom side includes four adjustable height feet 26, only two of which are visible in FIG. 1a. The box shaped housing allows stacking of plural instruments to form a biomanufacturing system. In practice, for convenience, the stack will be two or three high on a benchtop 5, as schematically illustrated in FIG. 1b, although there is no reason why the stack could not be higher. The instrument also includes a door 25, shown open and cut away for in order to shown the remaining parts of the instrument more clearly. The door is hinged at hinges 28 to the front vertical edge of the housing, so that it opens about a vertical hinge axis to expose or enclose an insulated chamber 30 inside the housing 20. The chamber 30 is sealed when the door is closed by an elastomeric seal 32 extending around the whole periphery of the inner face of the door and cooperating with a seal face 31 extending in a complementary manner around the front edges of the housing 20. No light enters the chamber 30 when the door 25 is closed. This negates light effects on the cell culture.

The chamber 30 has a main chamber 35 and an antechamber 33 leading to the main chamber 35. The main chamber includes a bioreactor tray 40, supported by a rocking tray support 45 described in more detail below. The rocking mechanism is protected by a cover plate 21. The antechamber 33 includes a panel 34 supporting two peristaltic pumps only the fluid handling heads 48 and 49 of which extend into the antechamber 33, the electrical parts of which are behind the panel 34. The panel also includes connections 43 described in more detail below. The antechamber 33 includes openings 46 defining a route for conduits extending to an external storage area which includes a bag hanging rack 50.

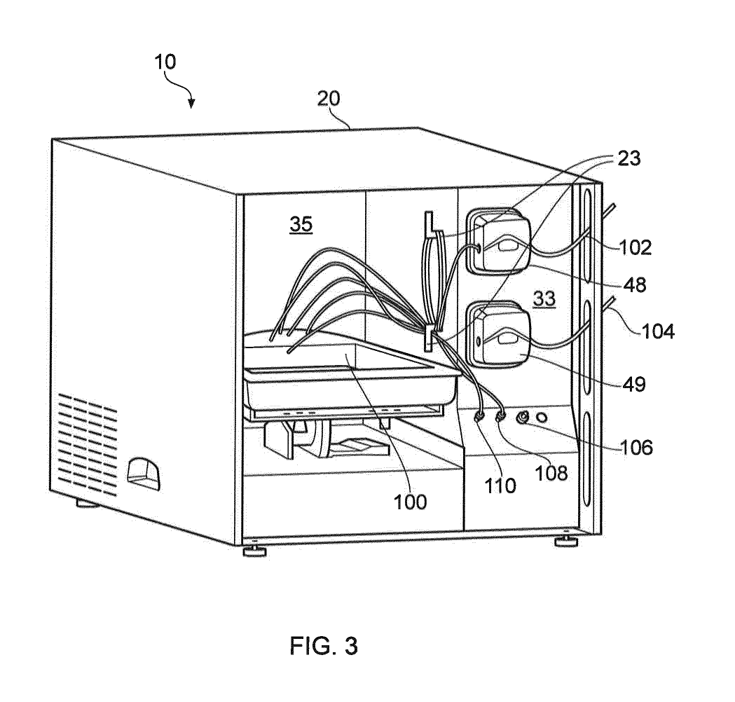

FIG. 2 is a different view of the instrument 10 shown in FIG. 1, with the door 25 and bag rack removed 50, in order to show the remaining parts of the instrument more clearly.

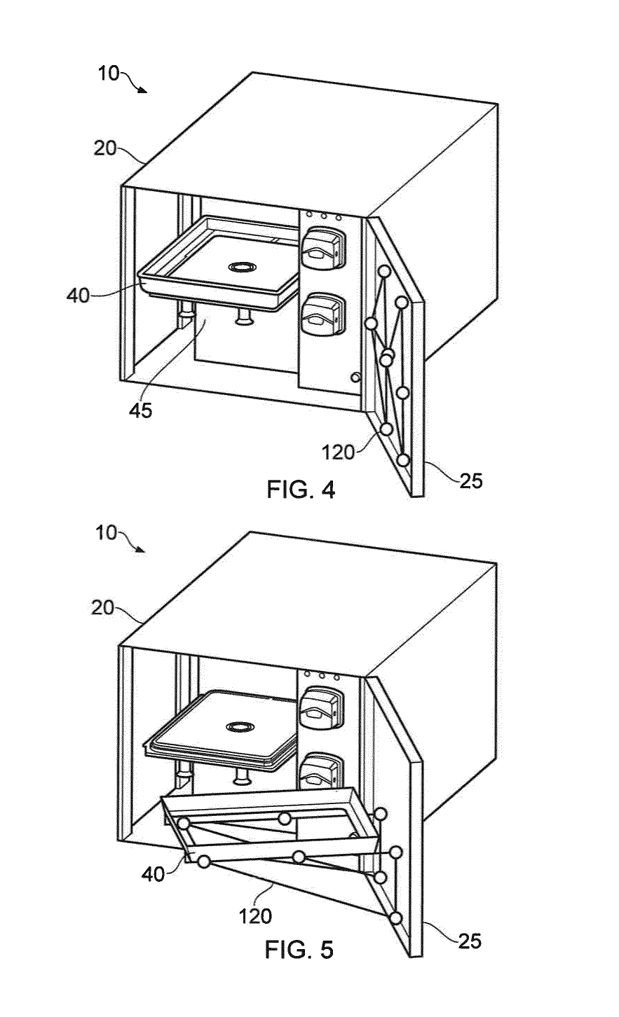

FIG. 3 shows the instrument 10 of FIGS. 1 and 2, but loaded with a bioreactor 100, in this instance, in the form of a flexible bag 100, as well as various paths linking the bioreactor to the instrument, including: a fluid supply conduit 102 feeding the bioreactor with a known mixture of fluids to promote cell growth via the peristaltic pump head 48, a fluid removal conduit 104 for drawing off fluids from the reactor for the purpose of removing waste components expressed by cells in the bioreactor via a filter incorporated in the bag 100 and via the peristaltic pump head 49; a gas feed conduit 106; and paths, for example electrically conductive paths 106, 108 and 110 for example electrical wires, for various sensors within or adjacent the bioreactor, for example a pH sensor, and a dissolved oxygen (DO) sensor. The conduits and paths can be kept in place by one or more hangers 23.

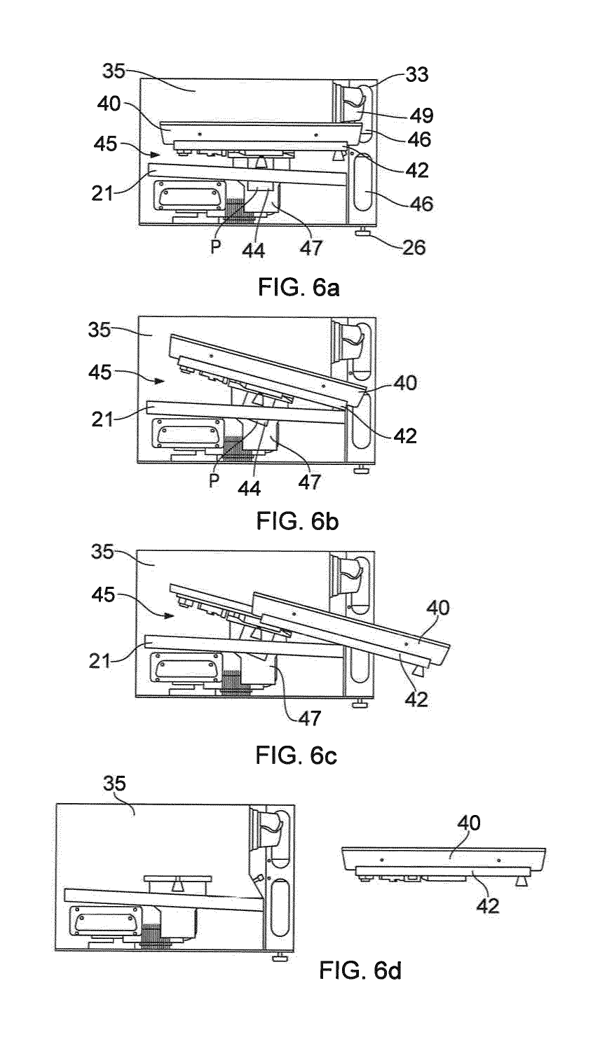

FIGS. 4 and 5 show an embodiment of the instrument 10 including the door 25. The tray in this embodiment is removable from the tray support 45 by sliding motion and can rest on a collapsible stand 120, in turn hung on the hinged door 25. In use, the door 25 can be opened, the stand 120 can be dropped down, and the tray 40 (without or without a bioreactor in place) can be slid away from the support 45 and manually moved onto the stand. It will be noted that the tray 40 has an open mid-section. This open section accommodates a bioreactor, which has clips that clip onto the tray 40 sides so that the bioreactor does not fall through the middle of the tray. Returning the tray full or empty back into the chamber 30, allows the frame 120 to be folded away and the door 25 to be closed shut.

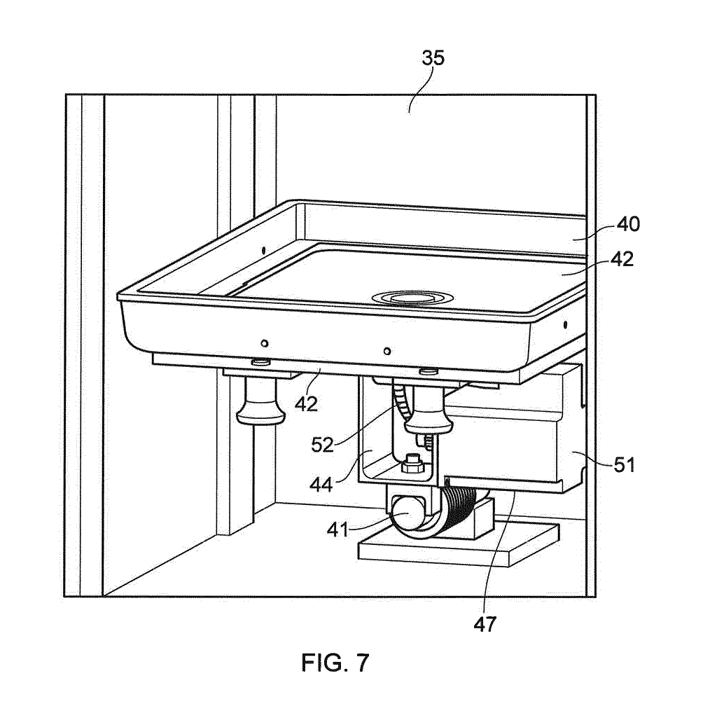

FIGS. 6a, 6b, 6c and 6d each show a sectional view of the main chamber 35 illustrated in FIGS. 1 to 3, and the components housed therein. Those components include the removable tray and the rocking tray support 45. The tray support 45 is formed from an electrically heated plate 42 which is in direct contact with the bottom of a bioreactor in use, a pivotable plate holder 44 which releasably holds the heated plate and an electrical stepper motor driving rocking mechanism 47 which moves the plate holder 44 back and forth about a pivot axis P below the tray 40 through a predefined angle of about 25-35 degrees. The support 45 is controllable in use so that it stops in any position, but in particular in the forward slopping position shown in FIG. 6b, which enables the tray and plate 42 to be slid forward together whilst the plate holder 44 stays in position, to a new position as illustrated in FIG. 6c, where the tray is more readily accessible for loading or unloading rather than having to remove it as shown in the embodiment of FIGS. 4 and 5. In the position shown in FIG. 6c the conduits and paths between the bioreactor and the instrument, as mentioned above, can be connected or disconnected more easily. The tray 40 and plate 42 can be removed completely as shown in FIG. 6d, for example, for cleaning purposes. A cover plate 21 protects the motor and other electrical parts.

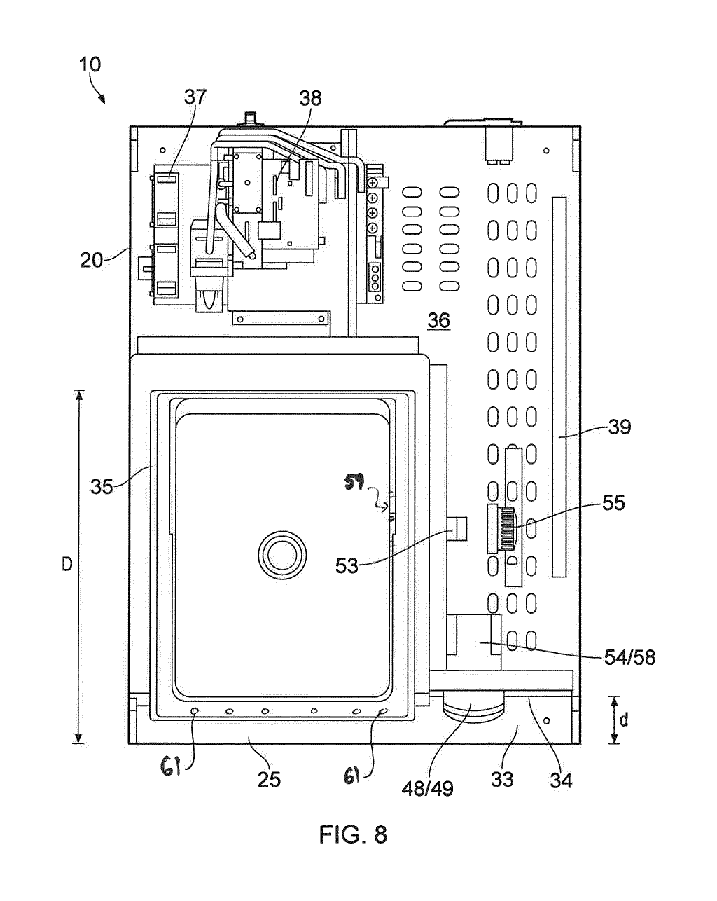

FIG. 7 shows the rocking mechanism in more detail view from the front, door, side of the instrument looking into the main chamber 35 with the cover plate 21 removed. A stepper motor 51 of the rocking mechanism 47 is shown as well as a reduction pinion gear pair 52 driven by the stepper motor and driving the plate support 44 to rotate back and forth. In this view a load sensor, in the form of a load cell 41 is visible which in use is used to measure the quantity of fluid added or removed from the bioreactor, and cell culture control.

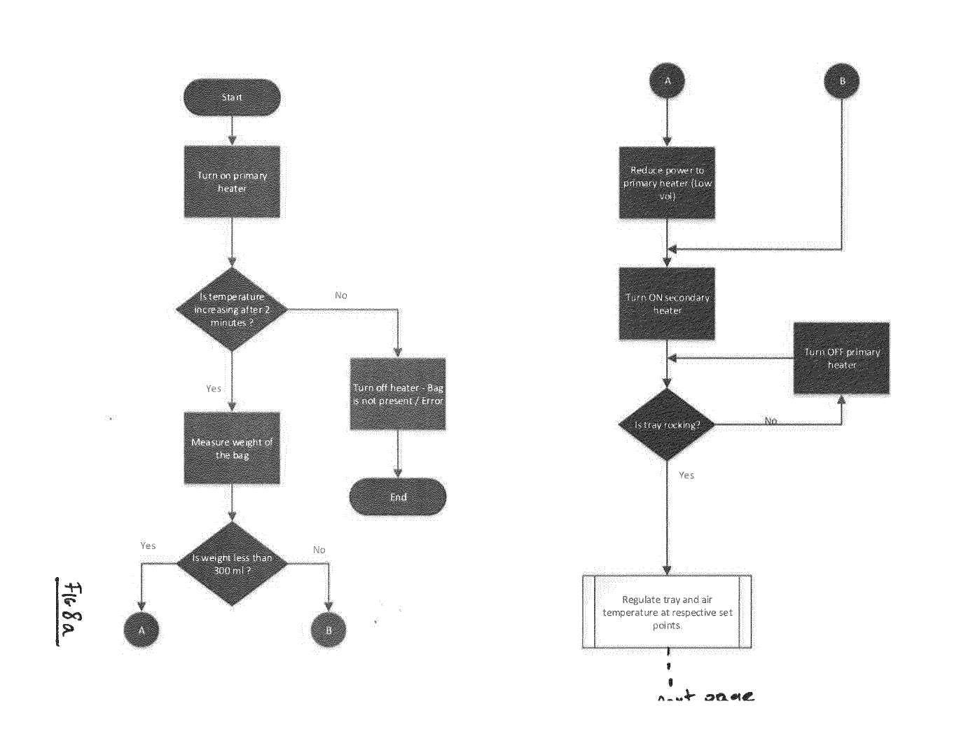

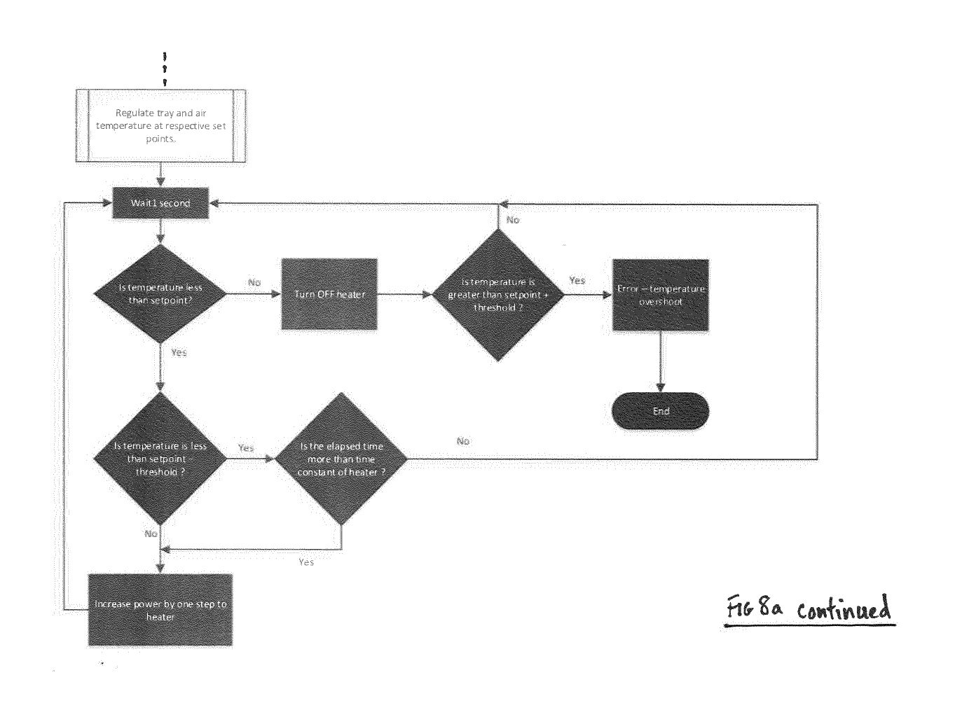

FIG. 8 shows a sectional view through the instrument 10 looking down such that the main chamber 35 is visible having a depth D from front to back, as well as the antechamber 33, which has a much shallower depth d. In the remaining region 36 of the housing is separated from the chambers 35/33 and encloses electrical and electronic control components which are kept way from possible leaks from the bioreactor and can be kept at lower temperature than the main chamber, so that electrical parts will have a longer life. In addition, cleaning of the electrical parts can be avoided because they are separated from the chambers 35/33. In more detail, those electrical/electronic components include a power supply 37, a perfusion gas supply control unit 38, a control circuit board 39, a chamber air heater 53, pump head 48/49 drive motors 54/58, a single board computer 55 and various connecting wires and conduits not shown.

In this embodiment the chamber air heater 53 includes an electrical resistance and an air fan for driving heated air into the main chamber 35, via an inlet duct 59 shown in FIG. 1, thereby controllably heating the chamber 35, by forced air convention, and hereby heating the air which surrounds any cell bag 100 used for cell culturing in the chamber 35, together with heating from the heated plate 42 (FIGS. 6a to 6d).

Since the cell bag as well as the region surrounding it is maintained at substantially the same temperature, condensation is inhibited, thereby maintain the pH at the prescribed level for optimum cell growth. The dual heating from the plate 42 and the heater 53 results in reduced heating time as well as mitigates condensation loss. It also ensures a generally uniform temperature gradient within the cell bag as well as inside the confined space.

The mentioned above, the enclosed region 36 of the bioreactor 1 houses the power supply, instrument PCBs, motors etc. There is a lot of heat generated in this area. The heating system harvests this waste heat effectively by directing this waste heat into the main chamber 35 via the duct 59. Temperature sensors 9 not shown) in the main chamber 35 and in the enclosed area 36 provide input to the heating system to determine the need for any further electrical heating of the forced air. In addition, each apparatus is well insulated so that there is little or no heating effect on other apparatus which may be positioned nearby.

During the entire cell expansion process, there is a need to take daily samples of the cell culture to monitor the progress of the cell expansion. For taking samples, the instrument door 25 is opened to access the cell bag on the tray 40. In this embodiment, plural vents 61 are present just behind the door which creates an air curtain blowing, for example downwardly, in front of the tray 40, so that when the door is opened for sampling, the air curtain ensures that there is no sudden dip in the temperature of the confined space. In this instance the vents 61 are fed from the fan 53, but an additional fan could be used with equal effect, for example a so called squirrel cage fan, where such a fan is operable only when the door is open. When the instrument door is kept open for extended period time due to user error, there is a warning alert given to the user (audible beeps or flashing display) to close the door.

Referring to FIG. 8a, a heating control flow chart is illustrated. For a low cell culture volume, it might not be safe to use the heater plate which is in direct contact with the cell bag to heat it. This could cause the cells to be overheated, putting the cell expansion process at risk. The tray 40 is directly mounted on a loadcell 41 which measures the change in weight of the cell bag contents. The heating system described herein thus senses if the cell culture volume is low and allows heating only by the secondary heater in this case. The cell bag contents are heated to the required temperature via the confined air in the chamber 35 around the tray 40 being heated by the heater 53. This ensures that the temperature does not overshoot beyond the set point and there is no loss of cells due to overheating. This is very critical especially for an autologous cell therapy where loss of cell sample is unacceptable given the often poor physical condition of the patients requiring the therapy.

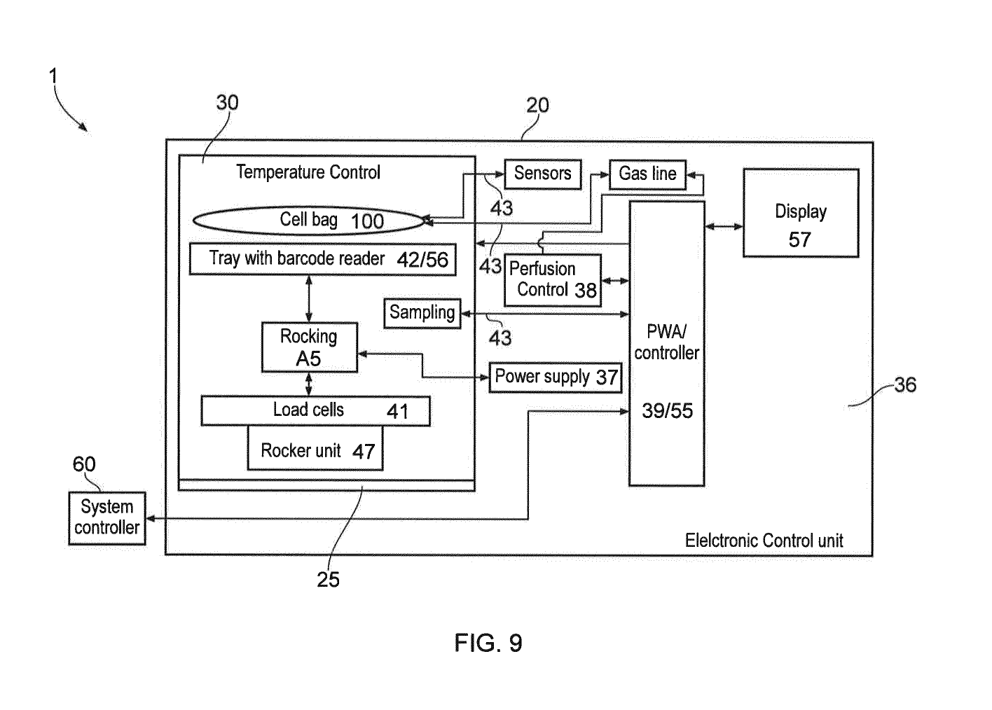

FIG. 9 shows schematic block diagram of the functioning of the instrument 10, with references relating to the physical components mentioned above and illustrated in the previous Figures. In use the flexible bag bioreactor 100 (cell bag) is preferred, and is loaded into the chamber as detailed above. Connections 43 are made and the door 25 is closed. The tray 42, in this embodiment includes a bar code reader 56, to reader a bar code from the bag and relay the identity of the bag to a controller 39/55. Other identification means are possible, for example an RFID transducer could be used, embedded in the cell bag 100. The identity of the bag will determine the appropriate cell culture regime, and additional, external information can be sought by the controller via a system controller 60, for example the target cell density required. Having determined the appropriate cell culture regime, the controller will, typically, control the temperature external to the bag, and optimise the parameters inside the bag. These parameters will vary during the cell culture period, i.e. over a period of up to 28 days, but typically 7 to 21 days. Thus the controller will monitor and adjust the internal pH of the cell culture, the dissolved oxygen content of the fluid in the bag, the weight of the bag to determine the amount of fresh fluid introduced and the amount of waste fluid withdrawn from the bag. Sampling of these parameters and the cell density is performed automatically. A continuous perfusion regime is preferred although other known regimes, such as a fed batch regime could be used. Conveniently, a display 57 is incorporated into the door 25, and the door includes a window which is darkened to reduce light entering the chamber or has a shutter, openable to view the chamber 30 through the window, but closable to reduce or exclude light in normal operation of the instrument.

In use the instrument will function as a stand-alone system using the display 57 to output status information, along with other stand-alone instruments where plural instruments are employed, meaning that no external control is required for the operation of the instrument or instruments. However, it is possible that the system controller 60 can be used, will function either to simply supply information relating to the requirements of the cell bag loaded in the instrument, or additionally monitor plural instruments, or with suitable software, to monitor and control each instrument, so that internal instrument control is dominant. The then subordinate controller 39/55 of each instrument can take back instrument control if communication with the system controller is lost. The communication between the instruments and the system controller is preferably a system BUS link for example a universal serial bus of know configuration, but a wireless link is possible, for example as specified by IEEE802.11 protocols operating at 0.9 to 60 GHz. It is envisaged that each instrument will be automatically recognised by software running on the system controller, without the need for any user input.

Once the cell culture is complete, as determined by sampling and or cell bag weight, it is removed from the instrument and used for its intended purpose, for example autologous cell therapy. Where it is the biomolecules produced by cultured cells that is of interest these can be removed when the cell bag is emptied, or they can be removed from the filtrate extracted from the bag during culturing. The chamber 30 is easily cleaned ready for the next bag to be introduced, with minimal down-time. Thus it is apparent that the instrument described above allows convenient loading and unloading of disposable bioreactors, and can be closely spaced in stacked rows so that the density of instruments is about 4 to 6 per metre squared when viewed from the instruments' front faces. A typical bioreactor 100 for use with the instrument 10, will be small by present day standards, i.e. approximately 50 millilitres and 2500 millilitres, and so the system described above is a small scale system, having multiple cell culture instruments, which are each readily accessible and controllable, and optimise the available space.

Although embodiments have been described and illustrated, it will be apparent to the skilled addressee that additions, omissions and modifications are possible to those embodiments without departing from the scope of the invention claimed.

1. A biomanufacturing apparatus, comprising a housing, a substantially enclosed bioreactor chamber inside the housing and a further substantially enclosed region inside the housing containing at least one of electrical parts and electronic control components, the chamber including: a tray for supporting a bioreactor, a tray support including a mechanism for rocking the tray in use the tray including a heater for contacting a bioreactor and heating the same, and the apparatus further comprising secondary heating for heating air surrounding the tray.

2. The apparatus of claim 1, wherein said secondary heating comprises means for drawing air from the enclosed region and for forcing that air into the chamber, and optional electrical heating means for further heating that air after it is drawn from the enclosed region.

3. The apparatus of claim 1, wherein the housing includes an access door and air vents are provided, opening into the housing adjacent the door, in use providing a curtain of air adjacent the door.

4. The apparatus of claim 3, wherein the curtain of air is provided only when the access door is open.

5. The apparatus of claim 1, wherein the bioreactor heater is arranged to provide for conductive heating of the bioreactor, and the chamber air heater is arranged for convective heating of the air or other gaseous atmosphere in the chamber, each heater being controlled by a temperature controller.

6. The apparatus of claim 1, further including a bioreactor in the form of a flexible cell bag supported on the tray, wherein the bioreactor can accommodate a capacity of between approximately 50 millilitres to approximately 2500 millilitres.

7. A method for heating a bioreactor contained in a bio manufacturing apparatus including a housing, having a cell culture chamber, a primary convention heating plate inside the chamber at least partially supporting the bioreactor, and secondary heating means for heating the air or other gaseous environment inside the chamber, said method comprising the steps of
a) monitoring the temperature of the bioreactor;
b) monitoring the weight of the bioreactor; and
c) controlling the primary and secondary heaters according to the monitored temperature and weight.

8. The method of claim 7, wherein the controlling step further includes not operating the primary heater or operating the primary heater at a reduced power if the weight of the bioreactor is below a predetermined weight threshold.

9. The method of claim 8, wherein the power supplied to the primary heater is incrementally increased if a predetermined temperature is not reached while the primary and secondary heating are activated.
